(19) United States
(12) Patent Application Publication
(10) Pub. No.: US 2024/0154084 A1
(43) Pub. Date: May 9, 2024

(54) METHOD FOR MANUFACTURING ELECTRODE FOR SECONDARY BATTERY

(71) Applicant: TOYOTA JIDOSHA KABUSHIKI KAISHA, Toyota-shi (JP)

(72) Inventor: Tomoyuki UEZONO, Okazaki-shi (JP)

(73) Assignee: TOYOTA JIDOSHA KABUSHIKI KAISHA, Toyota-shi (JP)

(21) Appl. No.: 18/466,381

(22) Filed: Sep. 13, 2023

(30) Foreign Application Priority Data
Nov. 7, 2022 (JP) 2022-178380

(51) Int. Cl. H01M 4/04; H01M 4/66

(52) U.S. Cl. CPC H01M 4/0404; H01M 4/0435; H01M 4/661; H01M 4/667; H01M 2004/029

(57) ABSTRACT

A method for manufacturing an electrode for a secondary battery includes a step of forming a first electrode layer on a first main surface of a first base material at a first density, a step of preparing a second electrode layer formed at a second density, a step of laminating the prepared second electrode layer on a second main surface of the first base material, and a step of applying an electrolytic solution to at least one of a surface of the second electrode layer in contact with the second main surface and the second main surface of the first base material before the step of laminating the second electrode layer.

### CROSS-REFERENCE TO RELATED APPLICATION

This application claims priority to Japanese Patent Application No. 2022-178380 filed on Nov. 7, 2022, incorporated herein by reference in its entirety.

### BACKGROUND

### 1. Technical Field

The present disclosure relates to a method for manufacturing an electrode for a secondary battery.

### 2. Description of Related Art

As a conventional method for manufacturing an electrode for a secondary battery, Japanese Patent No. 7008813 (JP 7008813 B) discloses a method of manufacturing a bipolar electrode by applying a positive electrode mixture slurry to a predetermined range of a first surface of a current collector, applying a negative electrode mixture slurry to a predetermined range of a second surface of the current collector, disposing an electrical insulating member on an outer peripheral side of the negative electrode mixture slurry, and then pressing the positive electrode mixture slurry, the negative electrode mixture slurry, and the electrical insulating member together.

### SUMMARY

However, as described in JP 7008813 B, when the positive electrode mixture slurry constituting the positive electrode layer and the negative electrode mixture slurry constituting the negative electrode layer are collectively pressed, the electrode layer that is easily compressed among the positive electrode layer and the negative electrode layer is preferentially pressed.

Therefore, it is difficult to form each of the positive electrode layer and the negative electrode layer at a desired density, and adhesion between the positive electrode layer, the negative electrode layer, and the current collector may decrease. In such a case, it is difficult to improve the battery capacity and the rapid charging performance. Further, there is a concern that the reliability is also lowered due to the decrease in adhesion.

The present disclosure has been made in view of the above-described problems. An object of the present disclosure is to provide a method for manufacturing an electrode for a secondary battery capable of enhancing adhesion between an electrode layer and a substrate and improving battery capacity and rapid charging performance.

A method for manufacturing an electrode for a secondary battery according to the present disclosure includes: a step of forming a first electrode layer at a first density on a first main surface of a first substrate; a step of preparing a second electrode layer formed at a second density; a step of laminating the prepared second electrode layer on a second main surface of the first substrate; and a step of applying an electrolytic solution to at least one of the second main surface of the first substrate and a surface of the second electrode layer to be in contact with the second main surface, before the step of laminating the second electrode layer.

According to the above configuration, the first electrode layer and the second electrode layer each formed at a desired density can be laminated on the first main surface and the second main surface of the first substrate. Therefore, high capacity and high-speed charging performance can be improved. In addition, by applying an electrolytic solution to at least one of the second main surface of the first substrate and the surface of the second electrode layer before laminating the second electrode layer on the first substrate, the adhesion of the second electrode layer to the first substrate can be enhanced by the liquid crosslinking force.

In the method according to the present disclosure, the step of preparing the second electrode layer may include a step of forming the second electrode layer on a surface of a second substrate and a step of pressing the second electrode layer formed on the surface of the second substrate. The step of laminating the second electrode layer may include a step of peeling off the second electrode layer from the second substrate.

According to the above configuration, the second electrode layer can be formed at the second density by pressing the second electrode layer before laminating the second electrode layer on the first substrate. The second electrode layer peeled off from the second substrate can be laminated on the first substrate.

In the method according to the present disclosure, an endless intermediate transfer member may be used as the second substrate. In this case, the step of laminating the second electrode layer may include a step of transferring the second electrode layer from the intermediate transfer member to the second main surface of the first substrate.

According to the above configuration, it is possible to continuously manufacture the electrode for the secondary battery while highly controlling the laminating position of the second electrode layer.

In the method according to the present disclosure, a first conveyance speed at which the first substrate on which the first electrode layer is formed is conveyed toward a transfer position to which the second electrode layer is transferred may be higher than a second conveyance speed at which the intermediate transfer member on which the second electrode layer is formed is conveyed toward the transfer position.

According to the above configuration, the shapes of the first electrode layer and the second electrode layer after lamination can be maintained satisfactorily.

In the method according to the present disclosure, a bonded body in which a first metal foil constituting the first main surface and a second metal foil constituting the second main surface are bonded to each other may be used as the first substrate.

According to the above configuration, the electrode for the secondary battery can be manufactured by forming the first electrode layer on the first metal foil of the bonded body and laminating the second electrode layer on the second metal foil of the bonded body.

In the method according to the present disclosure, a polarity of the first electrode layer and a polarity of the second electrode layer may be different from each other.

According to the above configuration, it is possible to manufacture a bipolar electrode capable of enhancing the adhesion between the electrode layer and the substrate and improving the battery capacity and the rapid charging performance.

According to the present disclosure, a method for manufacturing an electrode for a secondary battery capable of enhancing adhesion between an electrode layer and a substrate and improving battery capacity and rapid charging performance can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view showing an electrode for a secondary battery according to an embodiment;

FIG. 2 is a flowchart illustrating a manufacturing process of an electrode for a secondary battery according to the embodiment;

FIG. 3 is a view showing a step of forming a first electrode layer on a first main surface of a first substrate in the manufacturing step shown in FIG. 2;

FIG. 4 is a view showing steps in the manufacturing process shown in FIG. 2 until the second substrate is laminated on the first substrate after the first electrode layer is formed; and

FIG. 5 is a diagram showing conditions and results of a verification experiment.

### DETAILED DESCRIPTION OF EMBODIMENTS

Hereinafter, embodiments of the present disclosure will be described in detail with reference to the drawings. In the following embodiments, the same or common parts are denoted by the same reference numerals in the drawings, and the description thereof will not be repeated.

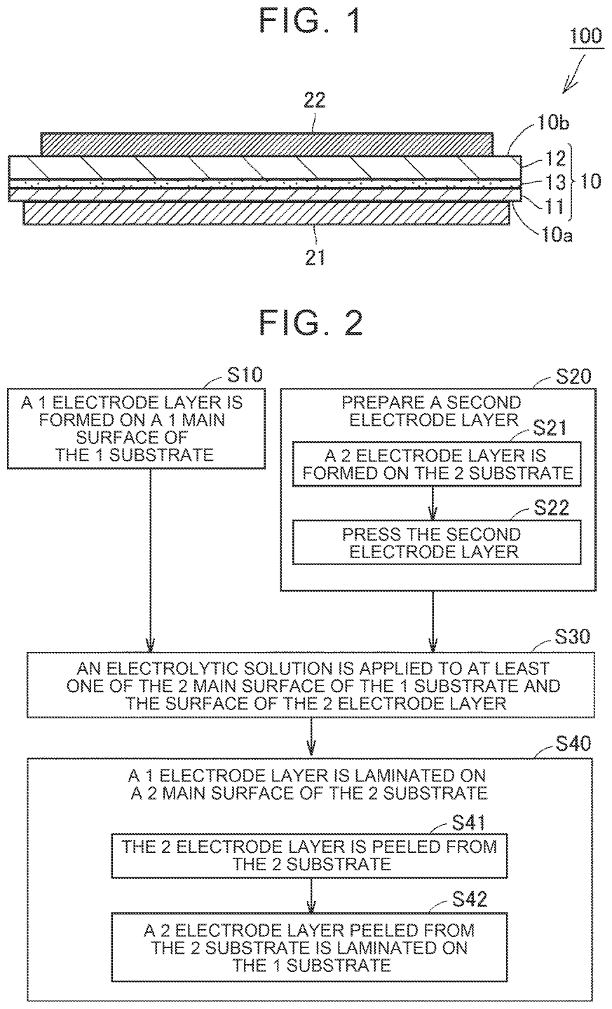

FIG. 1 is a cross-sectional view showing an electrode for a secondary battery according to an embodiment. Referring to FIG. 1, an electrode 100 for a secondary battery according to an embodiment will be described.

The electrode 100 is, for example, a bipolar electrode. The electrode 100 includes a first substrate 10, a first electrode layer 21, and a second electrode layer 22.

The first substrate 10 has a first main surface 10a located on one side in the lamination direction and a second main surface 10b located on the other side in the lamination direction.

The first substrate 10 is formed of a bonded body to which the first metal foil 11 and the second metal foil 12 are bonded. The first metal foil 11 and the second metal foil 12 are bonded to each other by an adhesive layer 13 interposed therebetween.

The first metal foil 11 constitutes the first main surface 10a. The first metal foil 11 is, for example, a negative electrode current collector plate. The first metal foil 11 may include at least one selected from the group consisting of stainless-steel, copper (Cu), Ni, Fe, Ti, cobalt (Co), and Zn. The first metal foil 11 is formed of, for example, a metal member such as copper foil.

The second metal foil 12 constitutes the second main surface 10b. The second metal foil 12, which is, for example, a positive electrode current collector plate, may include at least one selected from the group consisting of aluminum (Al), stainless steel, nickel (Ni), chrome (Cr), platinum (Pt), niobium (Nb), iron (Fe), titanium (Ti), and zinc (Zn). The metal foil is formed of, for example, a metal member such as an Al foil.

The first electrode layer 21 is formed on the first main surface 10a. The first electrode layer 21 is, for example, a negative electrode active material layer. The density of the first electrode layer 21 is, for example, about 1.2 g/cm³. With such a density, rapid charging performance can be improved. The negative electrode active material layer includes a negative electrode collector material and a binder.

The negative electrode active material may be, for example, a carbon-based negative electrode active material such as graphite, graphitizable carbon, or non-graphitizable carbon, or an alloy-based negative electrode active material including silicon (Si), tin (Sn), or the like. The binder may include, for example, at least one selected from the group consisting of PVdF, and vinylidene fluoride-hexafluoropropylene copolymer (PVdF-HFP).

The second electrode layer 22 is formed on the second main surface 10b. The second electrode layer 22 has a polarity opposite to that of the first electrode layer 21. The second electrode layer 22 is, for example, a positive electrode active material layer. The density of the second electrode layers 22 is, for example, about 3.3 g/cm³. With such a density, it is possible to increase the capacity. The density of the second electrode layer 22 is larger than the density of the first electrode layer 21.

When viewed from the stacking direction, the size of the second electrode layer 22 is larger than that of the first electrode layer 21. As a result, formation of dendrites on the second electrode layer 22 side can be suppressed, and deterioration in battery performance can be suppressed.

The positive electrode active material layer includes a positive electrode active material and a conductive material. In the present embodiment, since the electrolytic solution is applied to the positive electrode active material layer in the manufacturing process as described later, the positive electrode active material layer does not include a binder.

The positive electrode active material may include, for example, at least one selected from the group consisting of lithium cobaltate, lithium nickelate, lithium manganate, lithium nickel cobalt manganate (e.g., LiNi_{1/3}Co_{1/3}Mn_{1/3}O₂, etc.), lithium nickel cobalt aluminate, and lithium iron phosphate.

The conductive material may include, for example, at least one selected from the group consisting of carbon black (such as acetylene black), vapor-grown carbon fiber (VGCF), carbon nanotube (CNT), and graphene flakes.

FIG. 2 is a flowchart illustrating a manufacturing process of an electrode for a secondary battery according to the embodiment. Referring to FIG. 2, a method for manufacturing the electrode 100 for a secondary battery according to the embodiment will be described.

As illustrated in FIG. 2, the method for manufacturing the electrode 100 for a secondary battery includes a step (S10) of forming a first electrode layer, a step (S20) of preparing a second electrode layer, a step (S30) of applying an electrolyte solution, and a step (S40) of laminating a second electrode layer.

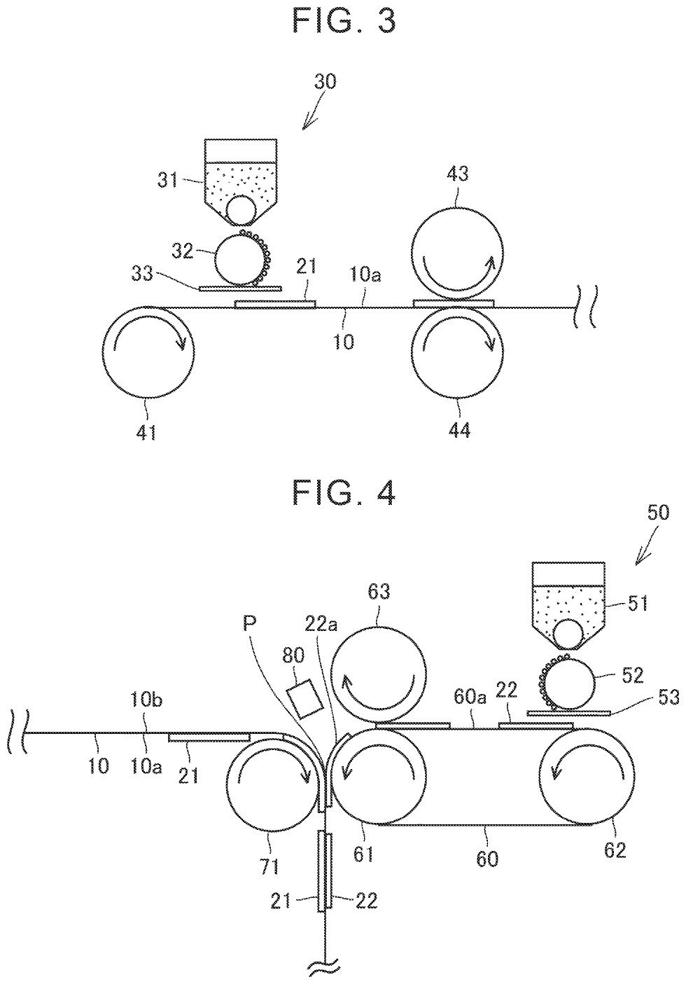

FIG. 3 is a view showing a step of forming a first electrode layer on a first main surface of a first base material in the manufacturing step shown in FIG. 2.

As shown in FIGS. 2 and 3, in manufacturing the electrode 100, in step (S10), the first electrode layers 21 are formed on the first main surface 10a of the first substrate 10. Specifically, for example, using the electrostatic screen device 30, the first electrode layers 21 are formed on the first main surface 10a of the first substrate 10 supplied from the supplying roller 41. The first substrate 10 is a bonded body in which the first metal foil 11 and the second metal foil 12 are bonded as described above.

The electrostatic screen device 30 includes a mixing tank 31, a supply unit 32, and a screen 33. In the mixing tank 31, the above-described negative electrode blocking material and binder are mixed to form a negative electrode composite. The negative electrode composite discharged from the mixing tank 31 is supplied to the screen 33 by the supply unit 32. The supply unit 32 is constituted by a roller. The screen 33 is formed of a metal mesh.

The negative electrode complex extruded from the mesh by the roller moves toward the first main surface 10a by an electrostatic field generated between the screen 33 and a support table (not shown) that supports the first substrate 10. As a result, the first electrode layers 21 are formed on the first main surface 10a. Subsequently, the first substrate on which the first electrode layer 21 is formed is conveyed so as to pass between the pair of press rollers 43 and 44. At this time, the pair of press rollers 43 and 44 sandwich and press the first electrode layer 21 at a predetermined temperature (for example, about 160° C.). As a result, the binder melts and the first electrode layer 21 is brought into close contact with the first main surface 10a, and is formed at a desired first density.

Note that the member for pressing the first electrode layer 21 is not limited to a pair of rollers, and may be a pair of flat plates or the like.

FIG. 4 is a view showing each step of laminating a second substrate on the first substrate after forming the first electrode layer in the manufacturing step shown in FIG. 2.

As shown in FIGS. 2 and 4, in the step (S20), the second electrode layer 22 having the second density is prepared. Specifically, first, in step (S21), the second electrode layer 22 is formed on the front surface 60a of the second substrate 60. The second substrate 60 is, for example, an endless intermediate transfer member, and is wound around the first roller 61 and the second roller 62.

When forming the second electrode layer 22, the electrostatic screen device 50 is used. The electrostatic screen device 50 includes a mixing tank 51, a supply unit 52, and a screen 53. In the mixing tank 51, the above-described positive electrode collector material and the conductive material are mixed to form a positive electrode composite. The positive electrode composite discharged from the mixing tank 51 is supplied to the screen 53 by the supply unit 52. The supply unit 52 is constituted by a roller, and the screen 53 is constituted by a metal mesh.

The positive electrode complex extruded from the mesh by the roller moves toward the front surface 60a of the second substrate 60 by an electrostatic field generated between the screen 53 and a support table (not shown) that supports the second substrate 60.

Subsequently, in step (S22), the second electrode layers 22 formed on the front surface 60a of the second substrate 60 are pressed. Specifically, the first roller 61 and the opposing roller 63 sandwich and press the second electrode layer 22. The opposing roller 63 is disposed so as to face the first roller 61 in a direction intersecting a direction in which the first roller 61 and the second roller 62 are aligned.

When the first roller 61 and the second roller 62 rotate, the second substrate 60 is conveyed. The second electrode layer 22 formed on the front surface 60a of the second substrate 60 passes between the first roller 61 and the opposing roller 63. At this time, the second electrode layer 22 is pressed by the first roller 61 and the opposing roller 63, and is formed at the second density. The second electrode layer 22 formed at the second density is conveyed toward the lamination position P (transfer position). The lamination position P is located on the downstream side in the conveyance direction from the press position (the nip portion between the first roller 61 and the opposing roller 63) of the second electrode layer 22.

Similarly, the first substrate 10 on which the first electrode layer 21 having the first density is formed is conveyed toward the lamination position P. The first substrate 10 is conveyed by a conveyance roller 71. The conveyance roller 71 is disposed to face the first roller 61 so that the lamination position P is positioned between the first roller 61 and the conveyance roller. In the lamination position P, the first substrate 10 is conveyed such that the second main surface 10b faces the first roller 61 side and the first main surface 10a faces the conveyance roller 71 side.

Subsequently, in step (S30), prior to laminating the second electrode layer 22 on the second main surface 10b of the first substrate 10, the electrolyte is applied to at least one of the second main surface 10b of the first substrate 10 and the front surface 22a of the second electrode layer 22 to be contacted with the second main surface 10b.

As the electrolytic solution, for example, a lithium-containing solvent is used. Specifically, the electrolyte solution is obtained by dissolving an electrolyte salt in an organic solvent. Examples of the organic solvent include esters such as propylene carbonate, ethylene carbonate, and γ-butyl lactone, ethers such as diethyl ether, tetrahydrofuran, substituted tetrahydrofuran, dioxolane, pyran and derivatives thereof, dimethoxyethane, and diethoxyethane, 3-substituted-2-oxazolidinones such as 3-methyl-2-oxazolidinone, and sulfolane, methylsulfolane, acetonitrile, and propionitol. These may be used singly or in combination of two or more thereof.

As the electrolyte salt, lithium salts such as lithium perchlorate, lithium borofluoride, lithium phosphofluoride, lithium chloride aluminate, lithium halide, and lithium trifluoromethanesulfonate can be used.

The electrolytic solution is applied by the electrolytic solution application device 80. The electrolytic solution application device 80 may be, for example, a die coater.

Subsequently, in step (S40), the second electrode layers 22 are laminated on the second main surface 10b of the first substrate 10. Specifically, in step (S41), the second electrode layer 22 is peeled off from the second substrate 60. Then, in step (S42), the second electrode layers 22 separated from the second substrate 60 are laminated on the first substrate 10.

In the present embodiment, the step (S41) and the step (S42) are performed substantially simultaneously. Specifically, when the first substrate 10 and the second electrode layer 22 pass between the first roller 61 and the conveyance roller 71, the second electrode layer 22 is sandwiched between the first roller 61 and the conveyance roller 71 while being conveyed. At this time, the second electrode layer 22 is separated from the second substrate 60, and the front surface 22a of the second electrode layer 22 contacts the second main surface 10b of the first substrate 10.

As described above, the electrolyte is applied to at least one of the front surface 22a and the second main surface 10b of the second electrode layer 22. Therefore, the second electrode layer 22 is brought into close contact with the second main surface 10b by the liquid cross-linking force. Further, the second electrode layer 22 is sandwiched between the first roller 61 and the conveyance roller 71, whereby the second electrode layer 22 is laminated (transferred) on the second main surface 10b.

Through such a process, the electrode 100 can be manufactured. When the second electrode layer 22 is transferred by using the transfer method, the electrode 100 can be continuously manufactured while the stacking position of the second electrode layer 22 is highly controlled.

Note that the first conveyance speed at which the first substrate 10 on which the first electrode layer 21 is formed is conveyed toward the transfer position (the lamination position P) at which the second electrode layer 22 is transferred is higher than the second conveyance speed at which the second substrate 60 on which the second electrode layer 22 is formed is conveyed toward the transfer position. As a result, the shapes of the first electrode layer 21 and the second electrode layer 22 after lamination can be favorably maintained.

As described above, according to the method for manufacturing the electrode for a secondary battery of the present embodiment, the first electrode layer and the second electrode layer each formed at a desired density can be laminated on the first main surface 10a and the second main surface 10b of the first substrate 10. Therefore, high capacity and high-speed charging performance can be improved. In addition, prior to laminating the second electrode layer 22 to the first substrate 10, by applying an electrolyte to at least one of the second main surface 10b of the first substrate 10 and the front surface 22a of the second electrode layer 22, the adhesion of the second electrode layer 22 to the first substrate 10 can be enhanced by the liquid cross-linking force.

### Verification Experiment

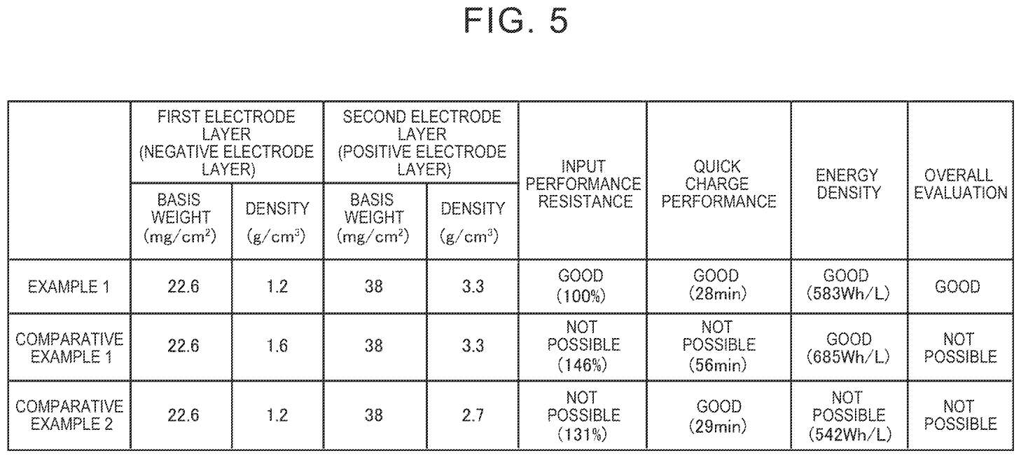

FIG. 5 is a diagram showing conditions and results of a verification experiment. A verification experiment will be described with reference to FIG. 5.

As shown in FIG. 5, in the verification experiment, the electrodes according to Example 1 and the electrodes according to Comparative Examples 1 and 2 were prepared. A secondary battery was manufactured using the electrodes according to Example 1 and the electrodes according to Comparative Examples 1 and 2. Then, I/O performance, rapid charging performance, and energy density were evaluated.

In evaluating the input/output performance, a small cell of 45 mm×47 mm degree was made by the monopolar construction, and IV resistivity was measured. The resistance values (mΩ) obtained in Example 1 and Comparative Examples 2 and 3 were compared in terms of ratios.

In evaluating the rapid charging performance, 1D simulation (Newman model simulation) was used to calculate the rapid charging performance from the physical properties of the fabricated electrodes.

In the evaluation of the energy density, it was calculated from the physical properties of the manufactured electrode using the following relational expressions (1) to (5).

Energy density (Wh/L)=Cell capacity (Wh)/Cell volume (L) Equation (1)

Cell volume (Wh)=Capacity (Ah)×Average voltage (V) Equation (2)
(*The average voltage is a value determined by the type of active material.)

Capacity (Ah)=active material ratio (%)×basis weight (mg/cm²)×number of stacked sheets×active material charge capacity (mAh/g)×initial coulombic efficiency (%)/electrode area (mm²) Equation (3)

Cell volume=electrode area×total thickness Equation (4)

Number of stacked sheets=total thickness/thickness of each cell Equation (5)

### Example 1

The electrode according to Example 1 was manufactured using the method for manufacturing the electrode for a secondary battery according to the present embodiment. The second electrode layer 22 did not include a binder. As the positive electrode active material and the conductive material included in the second electrode layers 22, NCM (lithium nickel cobalt manganate) and acetylene black were used, respectively. At this time, the ratio of the positive electrode active material to the conductive material (positive electrode active material/conductive material) was set to 95/5 (wt %).

Amorphous coat graphite and PVdF were used as the negative electrode material and the binder included in the first electrode layers, respectively. In this case, the ratio of the negative electrode active material to the binder (negative electrode active material/binder) was defined as 97.5/2.5 (wt %).

In the first substrate 10, a Cu foil was used as the first metal foil 11. The thickness of Cu foil was set to about 10 μm. As the second metal foil 12, an Al foil was used. The thickness of Al foil was set to about 40 μm. The thickness of the adhesive layer 13 was about 3 μm.

Based on the step (S10) described above, the first electrode layers 21 were formed on the first main surface 10a of the first substrate 10. At this time, the first electrode layers 21 were formed so that the basis weight was approximately 22.6 mg/cm² and the first density was 1.2 mg/cm³. The size of the first electrode layer 21 was set to be about the width 60 mm and the length 200 mm.

Based on the step (S20) described above, the second electrode layer 22 was formed on the second substrate 60. At this time, the second electrode layers 22 were formed so that the basis weight was approximately 38 mg/cm² and the second density was 3.3 mg/cm³. The size of the second electrode layer 22 was about the width 56 mm and the length 196 mm.

Based on the step (S30) described above, Sol-Rite was applied as an electrolyte to the front surface 22a of the second electrode layer 22 or the second main surface 10b of the first substrate 10.

Based on the step (S40) described above, the second electrode layer 22 was laminated (transferred) on the second main surface 10b of the first substrate 10 so that the second electrode layer 22 was disposed inside the region corresponding to the region where the first electrode layer 21 was formed.

At this time, the conveyance speed of the first substrate 10 was set to about 1.0 mm/min, and the conveyance speed of the second substrate 60 was set to about 0.7 mm/min. In addition, the transfer pressure at the time of transferring the second electrode layer 22 was set to about 2 kN.

In Example 1, the resistance value of the input/output performance was set to 100%. The rapid charging performance was 28 minutes. Good results were obtained. The energy-density became 583 Wh/L. Good results were obtained. As an overall evaluation, a good electrode was formed.

### Comparative Examples 1 and 2

The electrodes according to Comparative Examples 1 and 2 are different from the electrodes according to Example 1 in that a binder is used as the second electrode layer 22 and in the manufacturing process.

As the positive electrode active material, the conductive material, and the binder included in the second electrode layer 22 of Comparative Examples 1 and 2, NCM (lithium nickel cobalt manganate), acetylene black, and PVdF were used, respectively. At this time, the ratio of the positive electrode active material, the conductive material, and the binder (positive electrode active material/conductive material/binder) was set to 95/5/5 (wt %).

In the manufacturing process of the electrodes according to Comparative Examples 1 and 2, the first electrode layer 21 and the second electrode layer 22 were formed on the first main surface 10a and the second main surface 10b, respectively, without applying the electrolyte, and then the first electrode layer 21 and the second electrode layer 22 were pressed together.

Specifically, in manufacturing the electrodes according to Comparative Examples 1 and 2, first, the first electrode layer 21 was formed on the first main surface 10a of the first substrate 10 using an electrostatic screen method, and then the first electrode layer 21 was pressed at about 160° C. and a predetermined pressure. As a result, the binder contained in the first electrode layer 21 was melted, and the first electrode layer 21 was fixed to the first main surface 10a.

Subsequently, the second electrode layer 22 was directly deposited on the second main surface 10b of the first substrate 10 using the electrostatic screen method, and then the second electrode layer 22 was pressed at about 160° C. and at a predetermined pressure. As a result, the binder contained in the second electrode layer 22 was melted. Then, the second electrode layer 22 was fixed to the second main surface 10b.

Subsequently, the first electrode layer 21 and the second electrode layer 22 were densified together by roll pressing. At this time, the press pressure was changed in Comparative Example 1 and Comparative Example 2.

Thus, in the electrode according to Comparative Example 1, the first electrode layers 21 were formed so that the basis weight was approximately 22.6 mg/cm² and the first density was 1.6 mg/cm³. The second electrode layers 22 were formed so that the basis weight was approximately 38 mg/cm² and the second density was 3.3 mg/cm³.

In the electrode according to Comparative Example 2, the first electrode layers 21 were formed so that the basis weight was approximately 22.6 mg/cm² and the first density was 1.2 mg/cm³. The second electrode layers 22 were formed so that the basis weight was approximately 38 mg/cm² and the second density was 2.7 mg/cm³.

In Comparative Example 1, the resistance value of the input/output performance was 146%, which was significantly increased as compared with Example 1. The rapid charging performance was 56 minutes, and no favorable results were obtained. On the other hand, the energy-density is 685 Wh/L, and good results are obtained. As an overall evaluation, no good electrodes were formed.

In Comparative Example 2, the resistance value of the input/output performance was 131%, which was significantly increased as compared with Example 1. The rapid charging performance was 28 minutes, and good results were obtained. The energy-density became 542 Wh/L and did not give good results. As an overall evaluation, no good electrodes were formed.

### Results and Discussion

In the first embodiment, the density of the first electrode layer 21 and the density of the second electrode layer 22 can be independently controlled based on the manufacturing method according to the embodiment. Therefore, as intended, the first density of the first electrode layer 21 can be 1.2 mg/cm³, and the second density of the second electrode layer 22 can be 3.3 mg/cm³. Therefore, as described above, good rapid charging performance and energy density can be obtained. In addition, in Example 1, the second electrode layer was binder-less, and the second electrode layer 22 adhered to the first substrate 10 more closely than the liquid cross-linking force by applying the electrolytic solution, so that good input/output performance could be obtained.

On the other hand, in Comparative Example 1, since the first electrode layer and the second electrode layer are pressed together, when the density of the second electrode layer is adjusted to 3.3 mg/cm³, the pressing pressure of the first electrode layer is also increased, the density of the first electrode layer is 1.6 mg/cm³. From this, the rapid charging performance was greatly increased. In addition, since the density of the first electrode layers is too high, IV resistivity becomes high, and the input/output performance deteriorates.

Also in Comparative Example 2, since the first electrode layer and the second electrode layer are pressed together, when the density of the first electrode layer is adjusted to 1.2 mg/cm³, the pressing pressure of the second electrode layer decreases, and the density of the second electrode layer decreases to 2.7 mg/cm³. This significantly reduced the energy density. Further, since the density of the second electrode layer is low-density, the conductive pass cannot be obtained, IV resistivity is deteriorated, and the input-output performance is lowered.

As described above, it has been confirmed that the manufacturing method according to the present embodiment can manufacture an electrode for a secondary battery capable of enhancing adhesion between the electrode layer and the base material and improving battery capacity and rapid chargeability.

The embodiments disclosed herein are illustrative and not restrictive in all respects. The scope of the present disclosure is defined by the claims, and includes all modifications within the meaning and range equivalent to the claims.

What is claimed is:

1. A method for manufacturing an electrode for a secondary battery, the method comprising:
a step of forming a first electrode layer at a first density on a first main surface of a first substrate;
a step of preparing a second electrode layer formed at a second density;
a step of laminating the prepared second electrode layer on a second main surface of the first substrate; and
a step of applying an electrolytic solution to at least one of the second main surface of the first substrate and a surface of the second electrode layer to be in contact with the second main surface, before the step of laminating the second electrode layer.

2. The method according to claim 1, wherein
the step of preparing the second electrode layer includes a step of forming the second electrode layer on a surface of a second substrate and a step of pressing the second electrode layer formed on the surface of the second substrate, and
the step of laminating the second electrode layer includes a step of peeling off the second electrode layer from the second substrate.

3. The method according to claim 2, wherein
an endless intermediate transfer member is used as the second substrate, and
the step of laminating the second electrode layer includes a step of transferring the second electrode layer from the intermediate transfer member to the second main surface of the first substrate.

4. The method according to claim 3, wherein a first conveyance speed at which the first substrate on which the first electrode layer is formed is conveyed toward a transfer position to which the second electrode layer is transferred is higher than a second conveyance speed at which the intermediate transfer member on which the second electrode layer is formed is conveyed toward the transfer position.

5. The method according to claim 1, wherein a bonded body in which a first metal foil constituting the first main surface and a second metal foil constituting the second main surface are bonded to each other is used as the first substrate.

6. The method according to claim 1, wherein a polarity of the first electrode layer and a polarity of the second electrode layer are different from each other.
